(19) United States
(12) Patent Application Publication
(10) Pub. No.: US 2009/0144187 A1
(43) Pub. Date: Jun. 4, 2009

(54) SYSTEM, METHOD AND COMPUTER PROGRAM PRODUCT FOR DETERMINING UNDISCLOSED ORDER VOLUME

(75) Inventors: Milan BORKOVEC, Boston, MA (US); Hans G. HEIDLE, Quincy, MA (US); David HAN, Quincy, MA (US); Yossi BRANDES, Tel Aviv (IL)

Correspondence Address: ROTHWELL, FIGG, ERNST & MANBECK, P.C., 1425 K STREET, N.W., SUITE 800, WASHINGTON, DC, 20005, US

(73) Assignee: ITG SOFTWARE SOLUTIONS, INC., Culver City, CA (US)

(21) Appl. No.: 12/325,508

(22) Filed: Dec. 1, 2008

Related U.S. Application Data
(60) Provisional application No. 60/996,705, filed on Nov. 30, 2007.

(51) Int. Cl. G06Q 40/00

(52) U.S. Cl. 705/37

(57) ABSTRACT

Systems, methods, and computer program product for generating a report or document including a data representation reflecting a distribution of hidden trade order volume across different locations and a relative size, including average hidden order volume, volume executed against hidden orders, as a percentage of total trading volume by exchange, liquidity group and time bins. Order execution data is received for a plurality of executed trades via an electronic quotation feed associated with an electronic trading forum for trading both displayed orders and non-displayed orders. For a plurality of time periods, the location within the best bid, best offer spread, of each executed trade of the plurality of executed trades, is determined by comparing the price of each executed trade for hidden orders to quotes on a limit book for the electronic trading forum at a point in time substantially immediately before the corresponding executed trade.

### CROSS-REFERENCE TO RELATED APPLICATIONS

This application claims the benefit of U.S. Provisional Application Ser. No. 60/996,705 “System and Method for Providing a Hidden Volume Report,” filed on Nov. 30, 2007, the entire contents of which are incorporated herein by reference.

### BACKGROUND OF THE INVENTION

1. Field of the Invention

The present invention relates generally to systems and methods for identifying liquidity on financial exchanges and markets. More particularly, the present invention relates to novel systems and methods for generating a hidden order volume report.

2. Description of the Related Art

There is a demand among financial traders for more transparency and currency of market information in order driven electronic markets, such as the new level 2 and real-time data products offered by NASDAQ and NYSE. Markets which provide electronic limit order books, including, for example, Euronext, London Stock Exchange, XETRA, Spanish Stock Exchange, and Toronto Stock Exchange, provide a measure of currency and transparency.

An electronic limit order market is a trading platform where anonymous buyers and sellers post price-quantity pairs—i.e., the quoted bid (or ask) prices and associated quantities (depths) of a stock that the market participant is willing to buy (or sell). Limit order books offer market participants the ability to observe levels of market liquidity by displaying prices and quantities of unexecuted limit orders. Utilizing this data, market participants can implement a range of “game theoretical” strategies and choose limit orders with specified price, quantity, and timing, thus allowing them to minimize execution costs and uncertainty, hide market information, and possibly move the market towards the desired price.

Given concerns associated with information leakage due to order placements, some market venues allow market participants to enter “hidden” limit orders which do not reveal the full share volume size and/or the associated price level (also known as “iceberg”, “undisclosed”, or “discretionary” limit orders). This brings with it a complex interrelationship between exposure risk (adverse selection), market liquidity, and the need for transparency. From a market design point of view, hidden limit orders represent a trade-off between liquidity and transparency. Trading systems need to attract liquidity and trading activity. The availability of hidden limit orders encourages limit order traders, who are otherwise hesitant to fully disclose their trading interests, to supply liquidity—thus increasing the liquidity on the system. However, hidden limit order volume, by its nature, does not add information to the market and thus, does not help in the market's transparency.

In particular, hidden orders inside the spread will not attract activity to a venue, since most order routing systems can only operate on visible (i.e., displayed) information. Thus, as reported by ANANTH MADHAVAN, “Market microstructure: a survey”, Journal of Financial Markets, 3 (2000), pp. 205-258, hidden limit orders clearly diminish supposed benefits of transparent order driven markets: price efficiency, low costs of market monitoring and less information asymmetries.

The concept of hiding transaction fingerprints has been around for several years, but has recently seen increased popularity due to the advent of algorithmic trading systems such as ITG's “Dark Server” or CSFB's “Guerilla,” which utilize continuous mid-point crosses from “Dark Books.” For illiquid stocks, which have larger intra-day volatility, the concept of hiding transaction fingerprints allows the market participant to transact with minimum market impact.

In order to understand market conditions, and for other reasons, there is a need for systems and methods for generating a hidden order book report.

### SUMMARY OF THE INVENTION

Further applications and advantages of various embodiments of the present invention are discussed below with reference to the drawing figures.

A computer implemented method of generating a hidden order volume report is provided. In some embodiments, the method includes electronically receiving order execution data for a plurality of executed trades via an electronic quotation feed associated with an electronic trading forum for trading both displayed orders and non-displayed orders. For a plurality of time periods, there is a step for determining the location within the best bid, best offer spread, of each executed trade of the plurality of executed trades, by comparing the price of each executed trade for hidden orders to published quotes on a published limit book for the electronic trading forum at a point in time substantially immediately before the corresponding executed trade. A report is generated, for a plurality of asset classes for each time period, of hidden order volume location within the spread based upon the determining step.

According to embodiments of the present invention, data used to generate a hidden order volume report preferably covers a two-week period.

According to embodiments of the present invention, NASDAQ's ITCH data feeds are used to calculate the average hidden order volume, volume executed against hidden orders, as a percentage of total trading volume by exchange, liquidity group and time bins.

According to embodiments of the present invention, a report is generated including the average hidden order volume and total volume in each bin. As a result of the invention, a representation is generated reflecting how hidden order volume is distributed across different locations and its relative size.

### BRIEF DESCRIPTION OF THE DRAWINGS

FIG. 1 is a block diagram of a system for performing features of the present invention according to an embodiment of the present invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to the embodiments shown or described herein.

Electronic Communication Networks (ECNs) and Alternative Trading Systems (ATSs) may include undisclosed (e.g., “hidden” or non-displayed) order volume within their order book. ECNs and ATSs will electronically report trades to the NASDAQ (National Association of Securities Dealers Automated Quotations) after they have been consummated. NASDAQ, in turn, publishes information about executed trades.

ITCH is a direct data-feed interface that allows customers to observe or disseminate information about stock trading activities on the NASDAQ. ITCH facilitates the display of data concerning added, executed, modified, or canceled orders. It is also possible to exchange cross and stock directory information. Each ITCH feed is composed of a series of sequenced messages delivered with a higher-level protocol such as TCP (Transmission Control Protocol) or UDP (User Datagram Protocol). ITCH makes it possible for subscribers to track the status of each order from the time it is first entered until the time it is either executed or canceled. Subscribers can also disseminate or receive administrative messages. ITCH is intended for information exchange only.

The present invention can use the ITCH direct feeds data to calculate the average hidden order volume, volume executed against hidden orders, as a percentage of total trading volume by exchange, liquidity group and time bins. According to embodiments of the present invention, a report is generated including the average hidden order volume and total volume in each bin. As a result of the invention, a representation is generated reflecting how hidden order volume is distributed across different locations and its relative size.

According to embodiments of the present invention, data used to generate a hidden order volume report preferably covers a two-week period. The trading day is sliced into bins, for example, in a preferred embodiment, thirteen 30-minute bins are defined as follows:

| Bin | Time Interval |
|---|---|
| 1 | 09:30-10:00 |
| 2 | 10:00-10:30 |
| 3 | 10:30-11:00 |
| 4 | 11:00-11:30 |
| 5 | 11:30-12:00 |
| 6 | 12:00-12:30 |
| 7 | 12:30-13:00 |
| 8 | 13:00-13:30 |
| 9 | 13:30-14:00 |
| 10 | 14:00-14:30 |
| 11 | 14:30-15:00 |
| 12 | 15:00-15:30 |
| 13 | 15:30-16:00 |

The prices of trades executed against hidden orders, hidden order trades, are compared to the quotes on the published limit order book (e.g., received from NASDAQ via ITCH) immediately before each trade to determine the location of each such trade. The location of a hidden order trade is defined as in the following table.

| Location | Price Ranqe |
|---|---|
| ASK | [ASK. ASK] |
| ASKM | (P₂. ASK) |
| MID | [P₁. P₂] |
| BIDM | [BID. P₁) |
| BID | [BID, BID] |

The second column is the price range of hidden order trades for each location. ASK denotes the best ask price and BID denotes the best bid price.

P1 and P2 are determined using the methods outlined next. Let S denote the inside spread in cents and MQ denote the midquote immediately before a trade occurs; that is:

S=100×(ASK−BID),

and

$$M Q = \frac{BID + ASK}{2} .$$

Now we can determine the values of P1 and P2 for three different cases:

If S<4 or S=6, then P1=P2=MQ.

Otherwise, if S is an even number, then

$${P}_{1} = \{ \begin{matrix}M Q - \frac{int ( \frac{S - 1}{3} ) + ( S - 1 ) \% 3 - 1}{200} & if ( S - 1 ) \% 3 = 0 or 1 \\ M Q - \frac{int ( \frac{S - 1}{3} ) - 1}{200} & if ( S - 1 ) \% 3 = 2 ,\end{matrix} \\ and \\ {P}_{2} = \{ \begin{matrix}M Q + \frac{int ( \frac{S - 1}{3} ) + ( S - 1 ) \% 3 - 1}{200} & if ( S - 1 ) \% 3 = 0 or 1 \\ M Q + \frac{int ( \frac{S - 1}{3} ) - 1}{200} & if ( S - 1 ) \% 3 = 2.\end{matrix}$$

If S is an odd number, then

$${P}_{1} = \{ \begin{matrix}M Q - \frac{int ( \frac{S - 1}{3} ) - 1}{200} & if ( S - 1 ) \% 3 = 0 or 2 \\ M Q - \frac{int ( \frac{S - 1}{3} )}{200} & if ( S - 1 ) \% 3 = 1 ,\end{matrix} \\ and \\ {P}_{2} = \{ \begin{matrix}M Q + \frac{int ( \frac{S - 1}{3} ) - 1}{200} & if ( S - 1 ) \% 3 = 0 or 2 \\ M Q + \frac{int ( \frac{S - 1}{3} )}{200} & if ( S - 1 ) \% 3 = 1.\end{matrix}$$

Int(x) returns the integer obtained by truncating x towards zero, and x/y returns the modulus of x with repect to y.

The proportion of hidden order volume as a percentage of total trading volume of the same side can be defined as

$${Prop}_{ji} = \frac{{hiddenOrderVolume}_{ji}}{{hiddenOrderVolume}_{j} + {visibleOrderVolume}_{j}} \times 100 ,$$

where hiddenOrderVolumeⱼᵢ is the total hidden order volume at location i in bin j, hiddenOrderVolumeⱼ is the total hidden order volume in bin j regardless of location, and visibleOrderVolumeⱼ is the total visible order volume in bin j. The hidden order volume (HV) and the total volume (TV) reported in tables 1-22 are in shares traded. All the other numbers are percentages.

At least three types of orders are known which could contribute to hidden liquidity in a limit order book: Reserve Orders, Non-display Orders, and Pegged Orders.

Reserve orders have a round lot display size and corresponding non-display size. Incoming order flow has access to both the display and non-display portion of a booked reserve order. Minimum share quantity for a displayed order is 100 shares; this amount is replenished when the amount falls below 100 shares. A new timestamp is created for the replenished portion of the order each time it is replenished from reserve, while the reserve portion retains the timestamp of its original entry.

Non-display Orders are hidden from the market place both in the System and in the NBBO. All incoming order flow can interact with hidden orders until hidden size is exhausted or cancelled at the specified price.

Pegged Orders are orders that, after entry, have their price automatically adjusted by the System in response to changes in either the local inside bid or offer, or bids or offers in the national market system, as appropriate. A Pegged Order can specify that its price will equal the inside quote on the same side of the market (“Primary Peg”), the opposite side of the market (“Market Peg”), or the midpoint of the bid and offer (“Midpoint Peg”). A Pegged Order may have a limit price beyond which the order shall not be executed. In addition, the Primary Peg and Market Peg Orders may also establish their pricing relative to the appropriate bids or offers by the selection of one or more offset amounts that will adjust the price of the order by the offset amount selected. A Midpoint Peg Order is priced based upon the inside bid and offer, excluding the effect that the Midpoint Peg Order itself has on the inside bid or inside offer. A new timestamp is created for the order each time it is automatically adjusted.

Each stock is grouped into either Listed or Nasdaq by its primary listing exchange according to the classification indicated in the following table.

| | Listing Exchange | Exchange Code |
|---|---|---|
| Listed | American Stock Exchange | UA |
| | New York Stock Exchange | UN |
| | NYSE Arca | UP |
| Nasdaq | NASDAQ Global Select Market | UW |
| | NASDAQ Global Market | UQ |
| | NASDAQ Capital Market | UR |
| | NASDAQ OTC Bulletin Board | UU |
| | NASD Bulletin Board | UV |

The following discussions and exemplary report results include BUY trades only, but one skilled in the art will understand that the results are analogous for SELL trades.

### By Exchange

The Nasdaq stocks have a uniformly larger proportion of hidden order volume in the locations of ASKM and ASK, with a few exceptions observed in Liquidity Group 0. The Listed stocks have a larger proportion of hidden order volume in the location of BIDM. This pattern is more obvious and profound for groups with higher liquidity. For the location of MID, listed stocks have a smaller proportion of hidden order volume for groups with lower liquidity, but have a larger proportion of hidden order volume for groups with higher liquidity. Basically, it can be concluded that the incoming marketable limit orders for Nasdaq stocks have higher transaction costs than those for Listed stocks.

### By Liquidity Group

The proportion of hidden order volume in the location of ASKM is decreasing as stocks become more liquid, however, the proportion of hidden order volume is increasing with liquidity group. This pattern is less profound for Listed stocks.

### By Time Bin

Both the proportion of hidden order volume and the hidden order volume exhibit a U-shape, which is consistent with standard results about trading volume. The larger proportion of hidden order volume after the market opens and before the market closes suggests that more hidden order volume occurs when the market is volatile and active.

The results in the tables are based on aggregated data. Results based on more granular data can be made available through the LOB database. All numbers are cross-sectional means. For each side, the first four columns are percentages and the fifth and sixth columns are in shares traded.

TABLE 1
Nasdaq, Liquidity Group 0

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.73 | 1.68 | 10.70 | 2.95 | 244 | 1191 | 0.55 | 0.50 | 17.66 | 4.84 | 271 | 1535 |
| 2 | 3.07 | 1.74 | 16.10 | 4.07 | 794 | 1523 | 0.75 | 0.21 | 20.81 | 3.85 | 396 | 2032 |
| 3 | 3.66 | 0.08 | 19.70 | 3.48 | 410 | 1654 | 0.83 | 0.67 | 19.53 | 7.11 | 378 | 1752 |
| 4 | 1.98 | 0.02 | 21.38 | 6.64 | 793 | 2137 | 0.48 | 2.98 | 17.13 | 11.72 | 432 | 1353 |
| 5 | 0.00 | 1.27 | 15.38 | 2.67 | 96 | 1022 | 1.44 | 4.09 | 11.79 | 7.09 | 121 | 788 |
| 6 | 0.06 | 1.89 | 13.90 | 8.18 | 244 | 1305 | 1.32 | 2.51 | 15.06 | 8.56 | 261 | 873 |
| 7 | 1.13 | 4.82 | 18.80 | 3.61 | 311 | 1147 | 2.25 | 0.00 | 22.67 | 6.23 | 319 | 1065 |
| 8 | 2.64 | 0.69 | 19.72 | 2.64 | 81 | 1124 | 0.00 | 1.72 | 23.97 | 8.46 | 341 | 1329 |
| 9 | 4.30 | 1.12 | 25.64 | 6.59 | 348 | 901 | 0.00 | 1.72 | 17.78 | 7.92 | 359 | 1245 |
| 10 | 2.33 | 2.62 | 21.16 | 7.38 | 241 | 829 | 2.44 | 1.08 | 21.17 | 6.72 | 184 | 767 |
| 11 | 4.14 | 6.83 | 19.63 | 2.86 | 437 | 1358 | 1.29 | 0.69 | 14.30 | 12.87 | 335 | 1061 |
| 12 | 5.67 | 2.55 | 19.75 | 4.98 | 178 | 794 | 0.77 | 1.37 | 18.82 | 7.86 | 283 | 1163 |
| 13 | 1.20 | 4.46 | 19.24 | 4.51 | 326 | 1121 | 1.61 | 2.11 | 16.55 | 4.94 | 185 | 1190 |

TABLE 2
Nasdaq, Liquidity Group 1

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.59 | 1.40 | 21.17 | 3.94 | 277 | 970 | 1.14 | 1.24 | 20.78 | 4.38 | 247 | 1125 |
| 2 | 1.49 | 4.29 | 18.34 | 3.93 | 245 | 955 | 2.15 | 1.37 | 10.85 | 5.06 | 245 | 1084 |
| 3 | 2.53 | 2.84 | 17.27 | 4.52 | 239 | 1099 | 1.47 | 2.18 | 15.68 | 7.14 | 304 | 1140 |
| 4 | 1.66 | 3.01 | 18.67 | 5.88 | 396 | 1040 | 1.85 | 1.65 | 14.34 | 7.42 | 304 | 1101 |
| 5 | 2.19 | 2.15 | 13.68 | 5.36 | 331 | 1296 | 0.89 | 2.73 | 14.05 | 5.77 | 359 | 1188 |
| 6 | 2.54 | 2.93 | 18.88 | 4.69 | 392 | 953 | 1.03 | 3.08 | 14.27 | 5.72 | 289 | 1616 |
| 7 | 2.57 | 4.32 | 17.89 | 5.70 | 192 | 549 | 1.93 | 2.85 | 13.06 | 6.49 | 207 | 935 |
| 8 | 2.62 | 4.03 | 21.30 | 4.27 | 295 | 781 | 0.74 | 3.43 | 15.08 | 7.49 | 287 | 882 |
| 9 | 2.24 | 4.18 | 18.16 | 4.33 | 177 | 714 | 0.72 | 2.49 | 12.72 | 6.93 | 199 | 937 |
| 10 | 2.90 | 3.56 | 18.78 | 4.00 | 239 | 931 | 1.32 | 4.09 | 14.63 | 5.90 | 260 | 917 |
| 11 | 2.62 | 3.29 | 15.75 | 5.19 | 259 | 851 | 1.66 | 1.92 | 12.50 | 6.87 | 223 | 1022 |
| 12 | 1.85 | 4.13 | 14.04 | 6.75 | 463 | 1024 | 1.52 | 3.85 | 15.58 | 6.59 | 367 | 1030 |
| 13 | 1.76 | 3.29 | 18.22 | 5.29 | 350 | 1254 | 1.15 | 3.36 | 15.57 | 6.47 | 292 | 1203 |

TABLE 3
Nasdaq, Liquidity Group 2

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.51 | 2.24 | 20.85 | 3.16 | 299 | 1197 | 1.15 | 2.01 | 21.26 | 3.90 | 319 | 1456 |
| 2 | 1.82 | 3.26 | 16.47 | 4.54 | 386 | 1260 | 0.98 | 2.83 | 16.05 | 4.75 | 286 | 1377 |
| 3 | 2.25 | 3.38 | 14.47 | 4.17 | 263 | 998 | 1.41 | 2.74 | 12.89 | 4.51 | 258 | 1299 |
| 4 | 1.25 | 3.35 | 13.20 | 3.78 | 299 | 1047 | 1.65 | 2.92 | 14.83 | 4.76 | 310 | 1379 |
| 5 | 1.43 | 4.10 | 13.73 | 4.13 | 363 | 1080 | 1.38 | 2.92 | 12.11 | 4.90 | 291 | 1197 |
| 6 | 1.56 | 3.99 | 13.76 | 4.10 | 254 | 899 | 1.00 | 3.04 | 11.39 | 5.30 | 227 | 1180 |
| 7 | 1.76 | 3.66 | 12.42 | 4.57 | 250 | 863 | 1.62 | 3.43 | 12.25 | 4.62 | 208 | 1097 |
| 8 | 1.96 | 4.00 | 13.44 | 4.31 | 221 | 816 | 1.60 | 2.96 | 13.63 | 4.78 | 294 | 1126 |
| 9 | 1.68 | 3.11 | 14.03 | 4.08 | 204 | 892 | 1.41 | 3.20 | 13.18 | 4.88 | 307 | 1124 |
| 10 | 2.08 | 3.55 | 13.66 | 4.02 | 291 | 1033 | 1.18 | 3.20 | 11.03 | 5.22 | 243 | 1081 |
| 11 | 2.55 | 4.19 | 13.57 | 4.80 | 227 | 898 | 1.53 | 3.92 | 11.97 | 4.52 | 225 | 1170 |
| 12 | 1.77 | 4.32 | 14.51 | 4.11 | 260 | 937 | 1.57 | 5.17 | 11.56 | 4.36 | 323 | 1447 |
| 13 | 1.38 | 4.07 | 14.81 | 5.02 | 460 | 1551 | 1.63 | 3.91 | 14.79 | 5.45 | 563 | 1896 |

TABLE 4
Nasdaq, Liquidity Group 3

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 1.88 | 2.89 | 20.08 | 3.35 | 348 | 1482 | 1.73 | 2.90 | 21.15 | 3.30 | 371 | 1877 |
| 2 | 1.84 | 3.45 | 14.43 | 4.15 | 392 | 1437 | 1.22 | 2.74 | 12.14 | 3.96 | 312 | 1679 |
| 3 | 1.06 | 4.10 | 11.84 | 3.65 | 357 | 1331 | 1.41 | 2.63 | 10.03 | 3.96 | 283 | 1500 |
| 4 | 1.37 | 3.49 | 12.37 | 4.09 | 332 | 1262 | 1.12 | 2.45 | 10.15 | 4.67 | 316 | 1568 |
| 5 | 1.02 | 3.51 | 10.88 | 4.59 | 339 | 1249 | 1.00 | 3.11 | 11.27 | 3.53 | 232 | 1174 |
| 6 | 1.19 | 3.38 | 9.64 | 4.03 | 473 | 1574 | 1.37 | 3.31 | 9.38 | 3.58 | 267 | 1288 |
| 7 | 1.12 | 4.32 | 11.27 | 3.96 | 304 | 1193 | 1.62 | 2.98 | 10.48 | 4.22 | 245 | 1185 |
| 8 | 1.06 | 3.61 | 12.67 | 3.88 | 265 | 1126 | 1.29 | 3.86 | 9.15 | 3.80 | 291 | 1331 |
| 9 | 1.57 | 3.95 | 9.81 | 4.40 | 337 | 1149 | 1.28 | 3.52 | 9.71 | 4.11 | 207 | 1163 |
| 10 | 2.09 | 3.27 | 10.32 | 3.95 | 292 | 1327 | 1.20 | 4.14 | 10.18 | 4.37 | 298 | 1392 |
| 11 | 1.71 | 3.94 | 10.00 | 3.85 | 272 | 1304 | 1.30 | 3.37 | 9.32 | 3.74 | 244 | 1258 |
| 12 | 1.47 | 4.10 | 10.23 | 4.52 | 333 | 1418 | 1.51 | 3.73 | 8.59 | 3.78 | 308 | 1637 |
| 13 | 1.16 | 3.43 | 11.21 | 5.29 | 643 | 2547 | 1.30 | 3.60 | 10.10 | 4.57 | 517 | 2481 |

TABLE 5
Nasdaq, Liquidity Group 4

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.28 | 2.33 | 20.76 | 4.09 | 749 | 3942 | 1.68 | 2.24 | 21.35 | 3.92 | 830 | 3613 |
| 2 | 1.78 | 3.56 | 11.86 | 4.36 | 751 | 2998 | 1.60 | 3.86 | 12.12 | 4.66 | 722 | 3117 |
| 3 | 1.54 | 3.66 | 10.65 | 4.06 | 522 | 2305 | 1.21 | 2.92 | 9.17 | 4.68 | 604 | 2885 |
| 4 | 1.72 | 3.75 | 9.92 | 3.68 | 471 | 2128 | 1.36 | 3.59 | 9.17 | 4.19 | 550 | 2580 |
| 5 | 1.58 | 3.67 | 9.86 | 3.90 | 518 | 2155 | 1.22 | 3.72 | 10.03 | 4.12 | 477 | 2128 |
| 6 | 1.69 | 3.63 | 9.76 | 4.19 | 496 | 1929 | 1.33 | 3.62 | 9.25 | 4.37 | 426 | 2834 |
| 7 | 1.57 | 3.90 | 9.83 | 3.97 | 397 | 1692 | 1.52 | 4.03 | 8.92 | 4.47 | 403 | 1896 |
| 8 | 1.56 | 3.98 | 11.42 | 3.86 | 437 | 1880 | 1.30 | 3.65 | 9.34 | 4.71 | 486 | 2200 |
| 9 | 1.70 | 3.61 | 10.78 | 4.15 | 458 | 1876 | 1.72 | 3.46 | 8.74 | 4.71 | 427 | 2182 |
| 10 | 1.71 | 3.81 | 10.13 | 4.28 | 565 | 2298 | 1.39 | 3.84 | 8.55 | 4.18 | 448 | 2301 |
| 11 | 1.33 | 3.68 | 9.38 | 3.59 | 432 | 2870 | 1.17 | 3.93 | 8.08 | 4.24 | 463 | 2304 |
| 12 | 1.37 | 3.95 | 9.37 | 4.05 | 554 | 2521 | 1.22 | 3.73 | 8.34 | 4.59 | 606 | 2883 |
| 13 | 1.30 | 3.86 | 9.53 | 5.59 | 1080 | 4888 | 1.00 | 3.43 | 8.54 | 5.76 | 1052 | 5050 |

TABLE 6
Nasdaq, Liquidity Group 5

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.81 | 3.68 | 13.82 | 4.14 | 1421 | 4564 | 2.09 | 3.28 | 18.30 | 4.26 | 1101 | 4241 |
| 2 | 2.02 | 3.28 | 10.39 | 4.49 | 817 | 3383 | 1.53 | 3.08 | 10.88 | 4.25 | 984 | 3711 |
| 3 | 1.32 | 3.31 | 9.49 | 4.46 | 653 | 2819 | 1.46 | 2.85 | 8.15 | 4.29 | 806 | 3942 |
| 4 | 1.49 | 3.08 | 8.28 | 4.63 | 670 | 2617 | 1.65 | 3.09 | 7.87 | 4.64 | 643 | 3998 |
| 5 | 1.49 | 2.86 | 8.89 | 4.49 | 587 | 2580 | 1.41 | 3.34 | 8.55 | 3.81 | 469 | 2398 |
| 6 | 1.76 | 3.35 | 8.41 | 4.21 | 437 | 2015 | 1.92 | 3.76 | 7.77 | 4.38 | 486 | 2340 |
| 7 | 1.62 | 3.35 | 8.77 | 4.01 | 427 | 1985 | 1.78 | 3.45 | 8.28 | 4.12 | 441 | 2177 |
| 8 | 1.85 | 3.08 | 8.94 | 3.96 | 455 | 2129 | 1.68 | 3.70 | 7.74 | 4.19 | 573 | 2653 |
| 9 | 1.78 | 2.93 | 7.86 | 4.21 | 466 | 2227 | 1.91 | 3.41 | 8.19 | 4.09 | 513 | 2483 |
| 10 | 1.35 | 3.26 | 8.25 | 3.92 | 524 | 2814 | 1.58 | 3.41 | 7.54 | 3.74 | 497 | 2716 |
| 11 | 1.38 | 3.29 | 7.89 | 4.48 | 552 | 2589 | 1.53 | 3.29 | 7.70 | 4.00 | 614 | 3998 |
| 12 | 1.38 | 3.15 | 7.53 | 4.43 | 560 | 3085 | 1.27 | 3.60 | 8.12 | 4.37 | 618 | 3256 |
| 13 | 1.25 | 3.17 | 8.45 | 6.01 | 1401 | 6828 | 1.15 | 3.38 | 8.28 | 5.38 | 1192 | 6299 |

TABLE 7
Nasdaq, Liquidity Group 6

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.43 | 3.28 | 15.53 | 4.76 | 1549 | 5590 | 2.05 | 3.10 | 15.28 | 4.72 | 1463 | 6434 |
| 2 | 1.73 | 3.61 | 9.06 | 5.00 | 1378 | 5595 | 1.67 | 3.41 | 8.48 | 4.70 | 1084 | 5362 |
| 3 | 1.56 | 3.79 | 8.22 | 4.51 | 1080 | 4768 | 1.45 | 3.34 | 7.50 | 4.65 | 1080 | 5738 |
| 4 | 1.27 | 3.68 | 7.67 | 4.50 | 928 | 4142 | 1.40 | 3.50 | 7.23 | 4.42 | 930 | 4951 |
| 5 | 1.32 | 3.18 | 7.31 | 4.95 | 914 | 4040 | 1.44 | 3.76 | 7.25 | 4.39 | 862 | 4302 |
| 6 | 1.39 | 3.40 | 7.35 | 4.38 | 860 | 4037 | 1.69 | 3.78 | 7.32 | 4.43 | 811 | 3810 |
| 7 | 1.92 | 3.69 | 8.01 | 4.43 | 833 | 3778 | 1.92 | 3.97 | 7.35 | 3.98 | 774 | 3828 |
| 8 | 1.60 | 3.77 | 7.57 | 4.13 | 751 | 3654 | 1.79 | 3.87 | 7.01 | 3.96 | 755 | 3991 |
| 9 | 1.51 | 3.55 | 7.60 | 4.47 | 797 | 3854 | 1.57 | 3.81 | 6.88 | 4.21 | 745 | 4004 |
| 10 | 1.34 | 3.75 | 7.24 | 4.20 | 912 | 4626 | 1.49 | 3.96 | 6.61 | 4.28 | 855 | 4585 |
| 11 | 1.37 | 3.70 | 7.08 | 4.26 | 899 | 4381 | 1.54 | 3.85 | 6.65 | 4.12 | 833 | 4779 |
| 12 | 1.92 | 3.74 | 7.12 | 4.69 | 1091 | 5460 | 1.27 | 4.96 | 6.44 | 4.51 | 1022 | 5589 |
| 13 | 1.30 | 3.23 | 7.24 | 5.99 | 2165 | 11159 | 1.42 | 3.56 | 6.74 | 5.56 | 1900 | 10841 |

TABLE 8
Nasdaq, Liquidity Group 7

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.35 | 3.37 | 14.61 | 5.22 | 1930 | 7085 | 2.29 | 3.29 | 14.10 | 5.75 | 2311 | 8455 |
| 2 | 1.90 | 3.44 | 9.13 | 5.13 | 1409 | 6480 | 1.65 | 3.18 | 8.33 | 5.73 | 1547 | 7395 |
| 3 | 1.48 | 3.64 | 7.40 | 5.06 | 1089 | 5376 | 1.46 | 3.94 | 6.54 | 5.34 | 1322 | 6996 |
| 4 | 1.39 | 3.13 | 7.08 | 4.91 | 939 | 4746 | 1.42 | 3.25 | 6.68 | 5.70 | 1151 | 5729 |
| 5 | 1.53 | 3.36 | 7.49 | 5.20 | 905 | 4716 | 1.46 | 3.01 | 7.00 | 4.84 | 913 | 4999 |
| 6 | 1.86 | 3.74 | 7.13 | 5.14 | 866 | 4225 | 1.57 | 3.41 | 6.52 | 5.44 | 854 | 4553 |
| 7 | 1.75 | 3.43 | 7.38 | 4.68 | 825 | 4177 | 1.63 | 3.76 | 6.62 | 4.97 | 854 | 4458 |
| 8 | 1.57 | 3.70 | 7.71 | 4.48 | 895 | 4424 | 1.57 | 3.39 | 6.63 | 4.75 | 864 | 4758 |
| 9 | 1.75 | 3.62 | 7.28 | 5.07 | 914 | 4586 | 1.49 | 3.69 | 6.98 | 4.86 | 883 | 4864 |
| 10 | 1.57 | 3.62 | 6.85 | 5.25 | 1175 | 6010 | 1.44 | 3.62 | 7.00 | 4.89 | 1079 | 5888 |
| 11 | 1.33 | 3.67 | 7.15 | 5.24 | 1100 | 5584 | 1.51 | 3.78 | 6.48 | 4.96 | 1125 | 6183 |
| 12 | 1.32 | 3.65 | 6.58 | 6.99 | 1377 | 7014 | 1.32 | 3.89 | 6.32 | 5.20 | 1341 | 7351 |
| 13 | 1.26 | 3.29 | 7.11 | 6.94 | 2633 | 13475 | 1.25 | 3.46 | 6.47 | 6.66 | 2587 | 13871 |

TABLE 9
Nasdaq, Liquidity Group 8

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.38 | 3.56 | 13.50 | 6.46 | 3594 | 13018 | 2.17 | 3.10 | 12.66 | 6.48 | 3337 | 13580 |
| 2 | 2.15 | 3.60 | 7.81 | 6.46 | 2676 | 11782 | 1.77 | 3.46 | 7.98 | 6.37 | 2581 | 12420 |
| 3 | 1.85 | 3.73 | 6.94 | 6.92 | 2036 | 9818 | 1.69 | 3.51 | 6.46 | 5.80 | 2420 | 12665 |
| 4 | 1.71 | 3.47 | 7.43 | 6.09 | 1836 | 9015 | 1.68 | 3.58 | 6.25 | 6.37 | 2058 | 10549 |
| 5 | 1.62 | 3.45 | 6.16 | 6.28 | 1765 | 8510 | 1.73 | 3.44 | 7.45 | 5.36 | 1645 | 8820 |
| 6 | 1.62 | 3.75 | 6.23 | 5.96 | 1424 | 7369 | 1.73 | 3.91 | 6.08 | 5.77 | 1578 | 8508 |
| 7 | 1.70 | 3.61 | 6.71 | 6.00 | 1353 | 6997 | 1.92 | 3.69 | 6.08 | 5.52 | 1458 | 7749 |
| 8 | 1.73 | 3.76 | 6.71 | 5.58 | 1478 | 7726 | 1.74 | 3.96 | 5.98 | 5.57 | 1511 | 8470 |
| 9 | 1.74 | 3.92 | 6.39 | 5.83 | 1476 | 7821 | 1.72 | 3.77 | 6.05 | 5.72 | 1537 | 8363 |
| 10 | 1.59 | 3.96 | 6.39 | 5.83 | 1924 | 9745 | 1.85 | 3.92 | 5.72 | 5.50 | 1794 | 9554 |
| 11 | 1.37 | 3.86 | 6.52 | 5.92 | 1845 | 9442 | 1.45 | 3.81 | 5.71 | 5.80 | 1831 | 10371 |
| 12 | 1.62 | 3.96 | 6.51 | 6.25 | 2445 | 11962 | 1.51 | 4.02 | 5.79 | 5.84 | 2339 | 12748 |
| 13 | 1.51 | 3.60 | 5.96 | 7.37 | 4316 | 22205 | 1.45 | 3.69 | 5.34 | 6.90 | 4135 | 23257 |

TABLE 10
Nasdaq, Liquidity Group 9

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.75 | 4.07 | 11.90 | 8.32 | 13269 | 45670 | 2.56 | 3.98 | 11.21 | 8.40 | 12190 | 43451 |
| 2 | 2.30 | 4.87 | 7.38 | 8.00 | 9664 | 39700 | 2.02 | 4.51 | 7.02 | 7.84 | 8984 | 38555 |
| 3 | 2.61 | 4.86 | 6.45 | 7.75 | 7326 | 32235 | 1.67 | 4.48 | 5.84 | 7.53 | 7582 | 35655 |
| 4 | 1.97 | 4.47 | 6.86 | 7.48 | 6264 | 28259 | 1.64 | 1.20 | 5.86 | 7.30 | 6024 | 28986 |
| 5 | 1.90 | 4.69 | 5.86 | 7.39 | 5570 | 25594 | 1.70 | 4.36 | 5.20 | 6.67 | 4865 | 25241 |
| 6 | 1.89 | 4.70 | 5.58 | 7.38 | 4652 | 22118 | 1.64 | 4.56 | 5.18 | 6.89 | 4360 | 22266 |
| 7 | 1.81 | 4.57 | 5.58 | 7.21 | 4329 | 21270 | 1.66 | 4.66 | 5.14 | 6.71 | 4963 | 29988 |
| 8 | 1.75 | 4.83 | 5.67 | 6.67 | 4596 | 22775 | 1.62 | 4.69 | 5.17 | 6.74 | 4693 | 23652 |
| 9 | 1.84 | 5.01 | 5.47 | 7.04 | 4614 | 22320 | 1.70 | 4.80 | 5.63 | 6.64 | 4323 | 22427 |
| 10 | 1.78 | 4.98 | 5.18 | 6.83 | 5712 | 28615 | 1.63 | 4.74 | 4.98 | 6.41 | 4895 | 26880 |
| 11 | 1.59 | 4.82 | 5.61 | 6.98 | 5537 | 27503 | 1.55 | 4.77 | 5.26 | 6.71 | 5428 | 28927 |
| 12 | 1.66 | 5.04 | 5.49 | 7.03 | 7084 | 34890 | 1.47 | 4.61 | 5.09 | 6.71 | 6297 | 33545 |
| 13 | 1.47 | 4.40 | 4.40 | 7.62 | 12121 | 64959 | 1.33 | 4.24 | 4.38 | 7.11 | 10641 | 61799 |

TABLE 11
Nasdaq, Liquidity Group 10

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.38 | 5.59 | 9.25 | 10.74 | 117386 | 470096 | 2.11 | 5.14 | 9.34 | 9.95 | 103883 | 464483 |
| 2 | 1.73 | 5.64 | 7.49 | 9.63 | 76950 | 374082 | 1.70 | 5.23 | 7.41 | 8.38 | 62524 | 335128 |
| 3 | 1.73 | 5.78 | 7.47 | 8.66 | 52227 | 261645 | 1.58 | 5.38 | 6.29 | 8.91 | 53522 | 283377 |
| 4 | 1.74 | 6.90 | 6.70 | 8.82 | 49527 | 246494 | 1.45 | 5.06 | 6.53 | 8.42 | 48568 | 251147 |
| 5 | 1.53 | 5.91 | 6.74 | 7.63 | 36967 | 205331 | 1.23 | 5.01 | 6.20 | 7.80 | 36267 | 200613 |
| 6 | 1.18 | 5.66 | 6.37 | 7.58 | 30900 | 174430 | 1.32 | 4.90 | 6.05 | 7.58 | 30513 | 170973 |
| 7 | 1.10 | 5.74 | 6.02 | 7.66 | 27694 | 161316 | 1.27 | 4.98 | 6.35 | 7.44 | 27633 | 157844 |
| 8 | 1.49 | 5.50 | 6.45 | 7.23 | 29395 | 169257 | 1.17 | 5.02 | 6.28 | 7.49 | 31853 | 184401 |
| 9 | 1.44 | 5.48 | 6.79 | 7.84 | 33543 | 193771 | 1.30 | 5.41 | 5.84 | 6.79 | 32511 | 183654 |
| 10 | 1.57 | 5.54 | 6.11 | 7.14 | 42667 | 238239 | 1.33 | 5.49 | 6.32 | 6.27 | 39719 | 228300 |
| 11 | 1.28 | 5.26 | 6.48 | 7.68 | 41045 | 237687 | 1.29 | 5.39 | 6.05 | 6.24 | 37728 | 230219 |
| 12 | 1.36 | 5.81 | 5.57 | 6.72 | 48450 | 287975 | 1.34 | 5.46 | 5.91 | 6.58 | 42749 | 274910 |
| 13 | 1.22 | 5.37 | 4.47 | 7.35 | 74167 | 478136 | 1.05 | 5.39 | 4.08 | 6.94 | 76158 | 456418 |

TABLE 12
Listed, Liquidity Group 0

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 3.77 | 0.00 | 0.39 | 1.79 | 25 | 614 | 2.38 | 0.48 | 2.86 | 4.36 | 70 | 519 |
| 2 | 6.71 | 0.00 | 0.89 | 0.34 | 134 | 890 | 2.86 | 0.00 | 6.59 | 4.63 | 242 | 802 |
| 3 | 0.80 | 0.00 | 2.73 | 1.85 | 187 | 683 | 9.14 | 0.00 | 1.64 | 1.93 | 8 | 581 |
| 4 | 1.59 | 0.00 | 2.68 | 2.95 | 60 | 529 | 3.27 | 1.27 | 1.99 | 8.12 | 111 | 687 |
| 5 | 0.80 | 2.13 | 0.00 | 0.00 | 7 | 786 | 0.00 | 1.37 | 3.30 | 3.42 | 68 | 1186 |
| 6 | 0.80 | 3.70 | 1.85 | 1.23 | 22 | 572 | 1.69 | 0.00 | 7.27 | 4.62 | 95 | 590 |
| 7 | 2.94 | 2.94 | 3.19 | 0.00 | 21 | 754 | 1.06 | 0.00 | 1.06 | 1.70 | 21 | 298 |
| 8 | 2.33 | 4.65 | 0.00 | 3.73 | 63 | 599 | 8.69 | 5.32 | 3.70 | 2.40 | 63 | 431 |
| 9 | 0.80 | 0.11 | 4.27 | 4.12 | 78 | 587 | 1.69 | 0.42 | 5.83 | 9.15 | 285 | 628 |
| 10 | 0.34 | 0.00 | 2.55 | 3.69 | 373 | 1111 | 1.49 | 3.57 | 1.57 | 1.39 | 21 | 876 |
| 11 | 0.80 | 0.00 | 0.43 | 3.55 | 136 | 695 | 0.00 | 1.30 | 5.42 | 3.48 | 33 | 558 |
| 12 | 2.22 | 0.00 | 4.12 | 3.54 | 335 | 939 | 0.00 | 0.00 | 2.34 | 2.78 | 40 | 585 |
| 13 | 2.33 | 1.20 | 4.89 | 4.66 | 373 | 1281 | 9.64 | 0.89 | 1.04 | 1.98 | 25 | 482 |

TABLE 13
Listed, Liquidity Group 1

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 2.71 | 0.77 | 1.59 | 1.99 | 75 | 823 | 0.56 | 1.12 | 0.20 | 1.18 | 88 | 1043 |
| 2 | 1.44 | 0.86 | 2.38 | 1.05 | 32 | 672 | 0.59 | 0.76 | 4.03 | 1.90 | 87 | 830 |
| 3 | 2.43 | 1.72 | 3.98 | 1.34 | 75 | 732 | 0.47 | 0.39 | 3.11 | 1.79 | 48 | 735 |
| 4 | 3.73 | 1.38 | 3.97 | 1.79 | 90 | 626 | 1.62 | 0.99 | 3.72 | 2.70 | 114 | 839 |
| 5 | 3.42 | 1.69 | 3.59 | 1.50 | 86 | 632 | 1.33 | 1.34 | 3.84 | 1.61 | 84 | 833 |
| 6 | 4.53 | 2.42 | 5.82 | 1.84 | 47 | 669 | 0.84 | 0.91 | 3.09 | 2.14 | 82 | 671 |
| 7 | 2.27 | 0.72 | 0.41 | 1.55 | 110 | 677 | 0.31 | 0.82 | 1.86 | 1.98 | 50 | 761 |
| 8 | 3.47 | 2.81 | 3.49 | 1.94 | 202 | 770 | 1.84 | 1.43 | 3.62 | 1.43 | 44 | 859 |
| 9 | 3.39 | 1.73 | 4.57 | 1.77 | 86 | 600 | 1.24 | 1.21 | 3.60 | 2.09 | 56 | 786 |
| 10 | 1.76 | 1.87 | 5.05 | 1.07 | 85 | 561 | 1.00 | 1.33 | 2.99 | 1.75 | 115 | 808 |
| 11 | 2.01 | 1.52 | 3.80 | 2.12 | 96 | 612 | 1.22 | 1.49 | 3.98 | 1.62 | 86 | 708 |
| 12 | 2.17 | 1.71 | 4.40 | 1.43 | 151 | 785 | 1.22 | 1.08 | 3.60 | 1.39 | 61 | 782 |
| 13 | 2.08 | 2.46 | 4.50 | 1.65 | 91 | 803 | 1.32 | 1.47 | 3.22 | 1.72 | 89 | 757 |

TABLE 17
Listed, Liquidity Group 5

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 3.72 | 3.37 | 5.81 | 2.29 | 391 | 2139 | 2.97 | 2.84 | 5.54 | 2.17 | 429 | 2354 |
| 2 | 3.71 | 3.55 | 5.18 | 2.28 | 473 | 2426 | 3.19 | 3.47 | 5.43 | 2.50 | 458 | 2658 |
| 3 | 4.94 | 3.64 | 5.46 | 2.23 | 396 | 2007 | 3.16 | 3.42 | 4.80 | 2.30 | 462 | 2634 |
| 4 | 3.67 | 3.45 | 5.85 | 2.37 | 421 | 2022 | 3.50 | 3.82 | 5.12 | 2.20 | 419 | 2246 |
| 5 | 4.08 | 3.70 | 5.82 | 2.15 | 384 | 1808 | 3.55 | 3.42 | 4.79 | 2.22 | 352 | 2001 |
| 6 | 4.29 | 3.42 | 4.75 | 2.25 | 305 | 1547 | 3.47 | 3.84 | 4.89 | 2.46 | 359 | 1867 |
| 7 | 4.71 | 3.94 | 4.90 | 2.13 | 324 | 1594 | 3.67 | 3.36 | 5.00 | 2.38 | 309 | 1728 |
| 8 | 3.53 | 3.28 | 4.50 | 2.07 | 335 | 1729 | 3.71 | 3.58 | 4.29 | 2.07 | 326 | 1805 |
| 9 | 3.55 | 3.72 | 4.41 | 2.10 | 367 | 1908 | 3.50 | 3.44 | 4.59 | 2.16 | 331 | 1907 |
| 10 | 3.45 | 3.43 | 4.05 | 1.88 | 382 | 2289 | 3.90 | 3.69 | 4.33 | 2.41 | 403 | 2296 |
| 11 | 3.29 | 3.56 | 4.15 | 2.89 | 433 | 2348 | 3.43 | 3.48 | 4.45 | 2.29 | 437 | 2597 |
| 12 | 3.34 | 3.55 | 3.84 | 2.06 | 473 | 2633 | 2.97 | 3.52 | 4.58 | 2.30 | 514 | 2982 |
| 13 | 2.17 | 2.72 | 3.89 | 2.68 | 805 | 4817 | 2.27 | 2.85 | 3.68 | 2.76 | 787 | 5016 |

TABLE 18
Listed, Liquidity Group 6

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 4.16 | 4.18 | 7.27 | 2.93 | 763 | 3140 | 38.1 | 3.60 | 6.73 | 3.26 | 786 | 3208 |
| 2 | 4.62 | 3.97 | 5.87 | 2.57 | 825 | 3567 | 3.57 | 3.51 | 5.53 | 2.96 | 753 | 3616 |
| 3 | 4.27 | 4.35 | 5.63 | 2.58 | 693 | 3225 | 3.79 | 3.87 | 5.25 | 2.97 | 813 | 2863 |
| 4 | 4.24 | 4.14 | 5.17 | 2.64 | 596 | 2841 | 3.89 | 3.86 | 5.12 | 2.86 | 634 | 3185 |
| 5 | 3.92 | 3.99 | 4.63 | 2.47 | 535 | 2660 | 4.34 | 4.01 | 5.38 | 2.58 | 635 | 2846 |
| 6 | 3.55 | 3.92 | 5.07 | 2.60 | 546 | 2487 | 4.05 | 4.22 | 4.74 | 2.82 | 538 | 2680 |
| 7 | 4.48 | 3.97 | 5.04 | 2.77 | 548 | 2452 | 4.31 | 3.91 | 4.81 | 2.70 | 491 | 2580 |
| 8 | 3.89 | 3.68 | 4.92 | 2.39 | 495 | 2486 | 3.94 | 3.54 | 4.40 | 2.51 | 536 | 2655 |
| 9 | 4.13 | 4.96 | 4.52 | 2.40 | 533 | 2623 | 3.59 | 4.13 | 4.00 | 2.69 | 532 | 2662 |
| 10 | 3.58 | 3.74 | 4.16 | 2.26 | 573 | 3297 | 3.35 | 3.80 | 4.34 | 2.53 | 633 | 3251 |
| 11 | 3.08 | 3.55 | 4.44 | 2.66 | 644 | 3419 | 3.33 | 3.70 | 4.11 | 2.69 | 631 | 3403 |
| 12 | 3.19 | 3.89 | 4.15 | 2.44 | 783 | 4149 | 3.03 | 3.43 | 4.40 | 2.76 | 721 | 4044 |
| 13 | 2.65 | 3.10 | 3.65 | 3.06 | 1149 | 6906 | 2.44 | 2.93 | 4.29 | 3.33 | 1180 | 6748 |

TABLE 19
Listed, Liquidity Group 7

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 4.61 | 4.85 | 8.16 | 3.46 | 1558 | 5987 | 4.45 | 4.70 | 7.25 | 3.33 | 1271 | 5712 |
| 2 | 4.51 | 4.41 | 6.12 | 3.11 | 1409 | 6261 | 3.74 | 3.80 | 5.32 | 2.61 | 1112 | 5952 |
| 3 | 4.23 | 4.98 | 6.13 | 2.97 | 1083 | 5205 | 3.72 | 4.18 | 4.99 | 3.07 | 1124 | 5774 |
| 4 | 3.98 | 4.62 | 5.91 | 2.92 | 912 | 4481 | 3.65 | 4.82 | 4.81 | 2.79 | 879 | 4785 |
| 5 | 3.94 | 4.34 | 5.27 | 2.68 | 834 | 4261 | 3.59 | 4.16 | 4.59 | 2.51 | 799 | 4171 |
| 6 | 3.68 | 4.22 | 4.96 | 3.01 | 765 | 3914 | 3.76 | 4.82 | 4.65 | 3.12 | 747 | 3861 |
| 7 | 4.28 | 4.41 | 4.90 | 2.82 | 730 | 3726 | 4.32 | 4.43 | 4.88 | 2.69 | 696 | 3576 |
| 8 | 3.63 | 3.79 | 5.04 | 2.66 | 667 | 3783 | 3.77 | 3.98 | 4.38 | 2.56 | 748 | 3982 |
| 9 | 2.71 | 4.01 | 4.64 | 2.79 | 738 | 3991 | 3.62 | 4.85 | 4.53 | 2.59 | 748 | 3952 |
| 10 | 3.28 | 3.80 | 4.52 | 2.66 | 881 | 4884 | 3.62 | 3.89 | 4.31 | 2.59 | 858 | 4558 |
| 11 | 3.00 | 4.05 | 4.62 | 2.95 | 979 | 5289 | 3.34 | 4.00 | 4.23 | 2.60 | 924 | 5165 |
| 12 | 2.91 | 3.88 | 3.53 | 2.65 | 1132 | 6325 | 3.22 | 3.43 | 3.75 | 2.51 | 1118 | 6292 |
| 13 | 2.41 | 3.16 | 3.56 | 2.94 | 1706 | 10252 | 2.61 | 3.19 | 3.87 | 3.14 | 1715 | 10092 |

TABLE 20
Listed, Liquidity Group 8

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 4.76 | 4.84 | 8.98 | 3.87 | 2565 | 10257 | 4.22 | 4.98 | 7.67 | 3.90 | 2552 | 10798 |
| 2 | 4.82 | 4.62 | 6.85 | 3.59 | 2482 | 18932 | 3.98 | 4.09 | 5.44 | 3.25 | 2239 | 11099 |
| 3 | 3.85 | 4.78 | 5.74 | 3.66 | 2079 | 9172 | 3.68 | 4.64 | 5.51 | 3.35 | 2166 | 10182 |
| 4 | 3.97 | 4.96 | 5.65 | 3.31 | 1983 | 8506 | 3.84 | 4.44 | 5.16 | 2.98 | 1761 | 8738 |
| 5 | 3.84 | 4.44 | 4.83 | 3.39 | 1621 | 7677 | 3.85 | 4.64 | 4.62 | 3.11 | 1547 | 7783 |
| 6 | 3.66 | 4.56 | 4.75 | 3.35 | 1419 | 6668 | 3.73 | 4.63 | 4.56 | 3.16 | 1356 | 7016 |
| 7 | 4.14 | 4.86 | 4.91 | 3.27 | 1260 | 6156 | 4.92 | 5.00 | 5.15 | 3.24 | 1373 | 6471 |
| 8 | 3.64 | 4.78 | 4.71 | 3.01 | 1328 | 6693 | 3.77 | 4.55 | 4.68 | 2.94 | 1403 | 6968 |
| 9 | 3.97 | 4.64 | 4.85 | 3.23 | 1504 | 7002 | 3.77 | 4.87 | 4.58 | 3.00 | 1453 | 7295 |
| 10 | 3.36 | 4.40 | 4.77 | 3.16 | 1707 | 8898 | 3.57 | 4.74 | 4.89 | 3.00 | 1705 | 8645 |
| 11 | 3.28 | 4.49 | 4.45 | 3.31 | 1859 | 9416 | 3.66 | 4.42 | 4.68 | 3.15 | 1728 | 9313 |
| 12 | 3.25 | 4.18 | 3.82 | 3.12 | 2120 | 11305 | 3.63 | 4.55 | 3.71 | 2.87 | 2954 | 10981 |
| 13 | 2.32 | 3.65 | 3.77 | 3.18 | 2812 | 10141 | 2.37 | 3.62 | 3.79 | 7.11 | 2805 | 18022 |

TABLE 21
Listed, Liquidity Group 9

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 4.35 | 4.47 | 6.89 | 3.99 | 6651 | 30419 | 3.83 | 4.81 | 5.96 | 3.76 | 5453 | 30655 |
| 2 | 3.51 | 4.60 | 4.78 | 3.66 | 5623 | 29804 | 3.18 | 4.20 | 4.49 | 3.60 | 5328 | 29786 |
| 3 | 3.21 | 4.85 | 4.81 | 3.47 | 4390 | 24248 | 2.99 | 4.42 | 4.30 | 3.39 | 4644 | 26671 |
| 4 | 3.22 | 5.04 | 4.44 | 3.43 | 4020 | 21866 | 3.92 | 4.75 | 4.14 | 3.33 | 3944 | 22611 |
| 5 | 2.87 | 4.76 | 4.11 | 3.52 | 3583 | 19865 | 3.10 | 4.85 | 3.90 | 3.22 | 3218 | 19192 |
| 6 | 2.83 | 4.79 | 3.92 | 3.46 | 3089 | 16875 | 2.97 | 4.73 | 3.81 | 3.36 | 2878 | 16920 |
| 7 | 3.08 | 4.98 | 3.92 | 3.22 | 2872 | 15311 | 3.17 | 4.93 | 3.85 | 3.82 | 2688 | 15539 |
| 8 | 2.79 | 4.87 | 3.91 | 3.21 | 2927 | 16689 | 2.87 | 4.71 | 3.79 | 3.01 | 2847 | 17385 |
| 9 | 2.69 | 4.81 | 3.78 | 3.29 | 3069 | 17600 | 2.85 | 4.74 | 3.85 | 3.06 | 3005 | 17581 |
| 10 | 2.93 | 4.64 | 3.71 | 3.18 | 3568 | 20720 | 2.96 | 4.67 | 3.62 | 2.90 | 3215 | 20394 |
| 11 | 2.80 | 4.70 | 3.53 | 3.24 | 3670 | 21761 | 3.12 | 4.68 | 3.71 | 2.96 | 3487 | 21490 |
| 12 | 2.66 | 4.46 | 3.07 | 2.92 | 4310 | 16902 | 2.81 | 4.36 | 3.21 | 3.01 | 4146 | 26171 |
| 13 | 2.21 | 4.00 | 2.84 | 3.25 | 5941 | 39700 | 2.04 | 3.89 | 2.77 | 3.21 | 5555 | 38411 |

TABLE 22
Listed, Liquidity Group 10

| | BUY | | | | | | SELL | | | | | |
|---|---|---|---|---|---|---|---|---|---|---|---|---|
| Bin | BIDM | MID | ASKM | ASK | HV | TV | ASKM | MID | BIDM | BID | HV | TV |
| 1 | 3.27 | 6.52 | 5.17 | 5.53 | 43050 | 250832 | 2.75 | 5.66 | 5.86 | 5.29 | 39357 | 255494 |
| 2 | 2.41 | 7.98 | 3.49 | 4.53 | 34569 | 242327 | 2.23 | 6.14 | 3.48 | 4.49 | 31109 | 237280 |
| 3 | 2.10 | 6.89 | 3.27 | 4.41 | 28699 | 208993 | 2.89 | 6.42 | 3.24 | 4.24 | 29327 | 218691 |
| 4 | 2.14 | 6.99 | 3.47 | 4.33 | 25231 | 175881 | 2.08 | 6.32 | 3.22 | 4.20 | 23726 | 185381 |
| 5 | 1.98 | 6.86 | 2.99 | 4.35 | 21741 | 139026 | 1.88 | 6.39 | 2.87 | 3.88 | 18903 | 152740 |
| 6 | 1.92 | 6.78 | 2.82 | 4.45 | 18739 | 128711 | 2.83 | 6.53 | 2.85 | 3.79 | 16015 | 127450 |
| 7 | 1.94 | 6.94 | 2.84 | 4.29 | 16142 | 117898 | 2.09 | 6.87 | 2.74 | 3.83 | 16173 | 116785 |
| 8 | 2.94 | 6.63 | 2.90 | 3.84 | 18683 | 142870 | 1.98 | 6.62 | 2.88 | 3.82 | 18265 | 146251 |
| 9 | 2.86 | 6.58 | 2.83 | 4.39 | 20848 | 148945 | 2.99 | 6.78 | 2.79 | 3.63 | 17811 | 141885 |
| 10 | 1.96 | 6.45 | 2.70 | 3.83 | 23673 | 177513 | 2.98 | 6.65 | 2.72 | 3.79 | 22967 | 172660 |
| 11 | 1.91 | 6.47 | 2.89 | 3.95 | 22781 | 178986 | 2.84 | 6.45 | 2.53 | 3.73 | 22149 | 179504 |
| 12 | 2.89 | 6.60 | 2.48 | 3.56 | 27605 | 208661 | 1.95 | 6.83 | 2.30 | 3.81 | 28220 | 298371 |
| 13 | 1.56 | 6.92 | 2.01 | 3.58 | 39067 | 294112 | 1.53 | 6.86 | 2.02 | 3.67 | 37467 | 289858 |

One skilled in the art will recognize that the data generated from the systems and methods described herein can be stored in a data storage facility, such as a database, or made otherwise accessible to users, such as traders or algorithms, via a client interface or other known means. The information content can be used to better assess the amount of typical additional undisclosed liquidity for different liquidity groups, different time periods of the day and different regions at or between the best bid and ask levels. One skilled in the art will readily notice that the time of the day variable is just one specific factor that can determine the amount of hidden liquidity. The amount of hidden liquidity depends on many other factors such as, for instance, stock-specific effective spread, historical stock-specific volatility, day of week, or stock-specific real-time intra-day volatility. For each of these factors, similar historical-based reports can be computed which can then be incorporated, for example, in algorithmic servers to discover undisclosed volume or in the post-trade performance evaluation process to assess and enforce best execution.

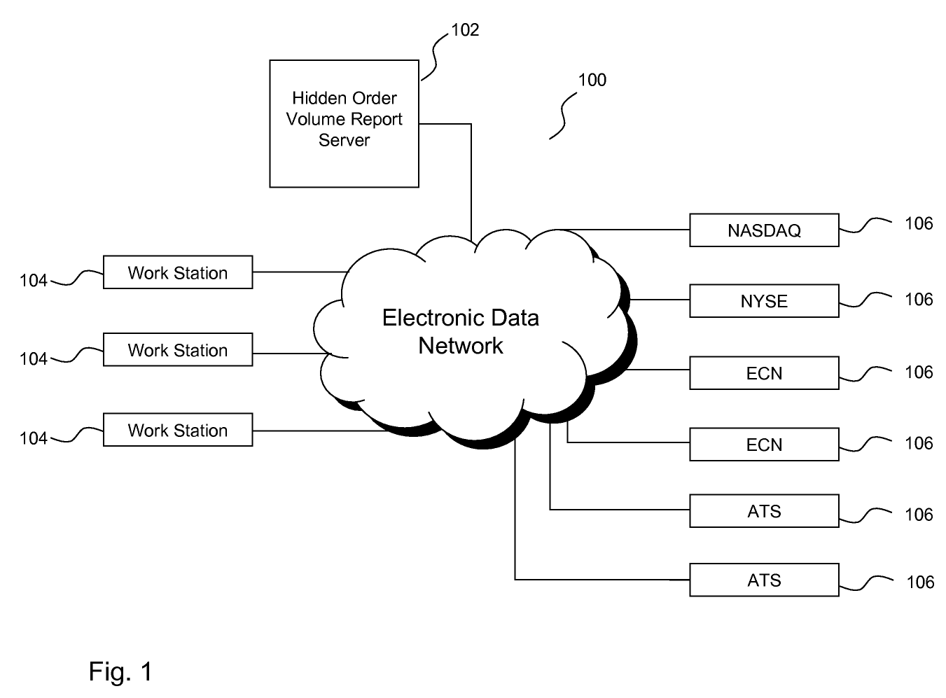

FIG. 1 is a block diagram of an exemplary system 100 that can be configured to perform aspects of embodiments of the present invention already described above. The system 100 can include a server 102 in communication with one or more user workstations 104, for example, via a direct data link connection or an electronic data network such as a local area network (LAN), an intranet, or internet. The server 102 and the work stations 104 can be computers of any type so long as they are capable of performing their respective functions as described herein. The computers can be the same, or different from one another, but preferably each have at least one processor and at least one memory device capable of storing a set of machine readable instructions (i.e., computer software) executable by at least one processor to perform the desired functions, where by “memory device” means any type of media or device for storing information in a digital format on a permanent or temporary basis such as, for example, a magnetic hard disk, flash memory, an optical disk, random access memory (RAM), etc.

Computer software stored on the server (“server software”), when executed by the server's processor, causes the server 102 to communicate with the workstations 104 and one or more data vendors 106, e.g., data services, exchanges, ATS's, ECN's, etc., that offer real-time securities data in an electronic format. For example, NASDAQ offers a quotation data feed in the format called ITCH, as described above.

The server software, when executed by the server's processor, also causes the server 102 to perform certain calculations, already described in detail above, using the data from the data vendors 106, as well as estimating the probability of hidden market orders, and providing hidden order volume data for display on one or more workstations 104.

The server 102 can be located at a user's facility or at a site remote from the user's facility. Communication between the server 102 and the data vendors 106 can be accomplished via a direct data link connection or an electronic data network, such as a LAN, an intranet, or internet. In alternate embodiments, one or more workstations can be configured to perform the server functions such that a dedicated server is not needed. It will also be appreciated that workstations can be configured to communicate individually with data vendors and/or local databases without being networked to a server or other workstations.

The data representation or reports can be formatted to be printed onto paper or other physical media as a document, etc.

A number of embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention. For example, as explained above, numerous other analytics could be calculated for the purpose of generating indicators of abnormal trading conditions for a security according to the present invention.

We claim:

1. A computer implemented method of generating a hidden order volume report, comprising:
electronically receiving order execution data for a plurality of executed trades via an electronic quotation feed associated with an electronic trading forum for trading both displayed orders and non-displayed orders;
for a plurality of time periods, determining the location within the best bid, best offer spread, of each executed trade of the plurality of executed trades, by comparing the price of each executed trade for hidden orders to quotes on a limit book for said electronic trading forum at a point in time substantially immediately before the corresponding executed trade; and
generating a report for a plurality of asset classes for each said time period, of hidden order volume location within said spread based upon said determining step.

2. The computer implemented method of claim 1, wherein said electronic quotation feed includes an ITCH data feed.

3. The computer implemented method of claim 1, wherein the determining step further determines the average hidden order volume, volume executed against hidden orders, as a percentage of total trading volume by exchange, liquidity group and time bins.

4. The computer implemented method of claim 1, wherein the report includes a representation reflecting a distribution of hidden order volume across different locations, and a relative size.

5. A system for generating a hidden order volume report, comprising:
at least one computing device configured to electronically receive order execution data for a plurality of executed trades via an electronic quotation feed associated with an electronic trading forum for trading both displayed orders and non-displayed orders;
at least one computing device configured to determine, for a plurality of time periods, the location within the best bid, best offer spread, of each executed trade of the plurality of executed trades, by comparing the price of each executed trade for hidden orders to quotes on a limit book for said electronic trading forum at a point in time substantially immediately before the corresponding executed trade; and
at least one computing device configured to generate a report for a plurality of asset classes for each said time period, of hidden order volume location within said spread based upon said determining step.

6. The system of claim 5, wherein said electronic quotation feed includes an ITCH data feed.

7. The system of claim 5, wherein the system is further configured to determine the average hidden order volume, volume executed against hidden orders, as a percentage of total trading volume by exchange, liquidity group and time bins.

8. The system of claim 5, wherein the report includes a representation reflecting a distribution of hidden order volume across different locations, and a relative size.

9. A computer recordable medium having executable computer instructions stored thereon for generating a hidden order volume report, by performing operations comprising:
electronically receiving order execution data for a plurality of executed trades via an electronic quotation feed associated with an electronic trading forum for trading both displayed orders and non-displayed orders;
for a plurality of time periods, determining the location within the best bid, best offer spread, of each executed trade of the plurality of executed trades, by comparing the price of each executed trade for hidden orders to quotes on a limit book for said electronic trading forum at a point in time substantially immediately before the corresponding executed trade; and
generating a report for a plurality of asset classes for each said time period, of hidden order volume location within said spread based upon said determining step.

10. The computer readable medium of claim 9, wherein said electronic quotation feed includes an ITCH data feed.

11. The computer readable medium of claim 9, wherein the determining operation further determines the average hidden order volume, volume executed against hidden orders, as a percentage of total trading volume by exchange, liquidity group and time bins.

12. The computer readable medium of claim 9, wherein the report includes a representation reflecting a distribution of hidden order volume across different locations, and a relative size.

13. A document including a data representation reflecting a distribution of hidden trade order volume across different locations and a relative size, including average hidden order volume, volume executed against hidden orders, as a percentage of total trading volume by exchange, liquidity group and time bins, the data representation generated by steps of:
electronically receiving order execution data for a plurality of executed trades via an electronic quotation feed associated an electronic trading forum for trading both displayed orders and non-displayed orders;
for a plurality of time periods, determining the location within the best bid, best offer spread, of each executed trade of the plurality of executed trades, by comparing the price of each executed trade for hidden orders to quotes on a limit book for said electronic trading forum at a point in time substantially immediately before the corresponding executed trade; and
generating a report for a plurality of asset classes for each said time period, of hidden order volume location within said spread based upon said determining step.

14. The document of claim 13, wherein said electronic quotation feed includes an ITCH data feed.

15. The document of claim 13, wherein the determining step further determines the average hidden order volume, volume executed against hidden orders, as a percentage of total trading volume by exchange, liquidity group and time bins.

16. The document of claim 13, wherein the report includes a representation reflecting a distribution of hidden order volume across different locations, and a relative size.
